(19) United States
(12) Patent Application Publication
(10) Pub. No.: US 2003/0158856 A1
(43) Pub. Date: Aug. 21, 2003

(54) Profile integrator and method thereof

(75) Inventors: Takashi Nishigaya, Yokohama (JP); Shigeki Fukuta, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/338,841

(22) Filed: Jan. 9, 2003

(30) Foreign Application Priority Data
Feb. 20, 2002 (JP) 2002-042537

(51) Int. Cl. G06F 17/00

(52) U.S. Cl. 707/102

(57) ABSTRACT

A profile integrator that configures data integration of profiles that stores the settings of the information service for each user, and allows setting of integration of profiles with different structures. Candidates of integration of profile data is created by comparing similarity of the structure of said profile, or comparing similarity of vocabulary included in the sample data that was read out from said profile, and an administrator selects data integration from the candidates. Thus, setting of data integration is carried out.

### CROSS-REFERENCE TO RELATED APPLICATIONS

This application is related to and claims priority to the Japanese Patent Application entitled “A profile Integrator and Method Thereof, ” having serial number 2002-042537, filed Feb. 20, 2002, and incorporated by reference herein.

### BACKGROUND OF THE INVENTION

1. Field of the Invention

The present invention relates to an apparatus, method, and computer readable storage that integrates data having different data representation systems and data structures. In particular, it relates to a profile that manages the information service status of multiple computers connected via a network.

2. Description of the Related Art

### SUMMARY OF THE INVENTION

Currently, there are membership information sites that cope with the diversification of services on the Internet and the diversification of the Internet connections from mobile phones. These sites provide a obtain a number of uses by providing a variety of services to many users.

As illustrated in FIG. 21, individual web services have a data structure called a profile for each user. A profile is a set of data that stores an individual's information and an individual's configuration for each user. Information sites can provide services unique to each user using this profile.

However, when a user uses a different service at the same information site, a new profile is created so that even the information already entered in the profile for other services is required to be entered. Therefore, when an information site starts a new service, a number of users have to newly create their profile.

FIG. 22 illustrates a system such as that found in Japanese Patent JP H12-152367, entitled “A multiple profile managing device, managing method and program recording medium for multiple profile managing. ” Illustrated therein is an invention in which a multiple profile managing device integrates data with the same content from multiple profiles to create a virtual integrated profile, so that it can be treated as an integrated single profile from each service point of view.

Therefore, when a new service is provided, that content that has already been entered in another profile is not required to be newly created, and by using the existing profile, it reduces the burden on managers and users of the information site. In addition, when one of the integrated profiles of data is renewed, the data in the linked profile is renewed as well, so that managers and users of the information site do not need to renew the data of the linked profile.

However, the problem with systems like Japanese Patent JP H12-152367 is that integration of multiple profiles is managed and processed by a computer (hereinafter referred to as multiple profile managing computer) having a single multiple profile manager. In this case, a single multiple-profile managing computer always processes access to any profile data, and consequently the operation load for all profiles is concentrated on the multiple-profile managing computer, which easily decreases the speed. Furthermore, it has a problem such that, when the multiple profile-managing computer stops, processes that involve profiles cannot be carried out at all and consequently the entire service stops.

Therefore, a multiplicity of multiple profile managers that carry out linking operations between profiles based on the configured integration status for each profile to be integrated are used. This prevents a concentration of processes involving profiles at a single location, and also allows the management and operation of each profile individually after the integration.

In the prior art systems such as JP H12-15367, there was a problem such that integration of all data was limited to the cases where the data type was completely identical, and they needed to be the same data type. Therefore, even if one profile of data was identical to the content of the other profile of data, they could not be handled as the same data by integrating them.

To address these problems, one possible solution is a data conversion with a multiple-profile managing computer by configuring the data conversion between the data to be integrated when data integration between different profiles is defined. However, future profiles will tend to employ the XML format, which can represent an arbitrary data structure including a table format by taking portability into account. XML data based on the XML-schema, which is a standard specification with regard to the XML data structure regulation, can represent complicated data formats based on an object orientation, and therefore a data format other than text is not required to be considered as a data element in the profile, and these data conversions will be more frequent for the XML format profile.

However, in the case of a simple table structure with completely identical data integration as in JP H12-152367, although the configuration for the data integration is simple, the multiple-profile managing is dispersed, and the more the profile data structure becomes complicated, the more difficult it is to configure the data integration between profiles.

Thus, It is an aspect of the present invention to provide improvements over the prior art, to be discussed below.

These aspects can be attained by a profile integration device that includes a profile integrator creating integration link information setting the integration of profile data that stores the settings of the information service for each user; a profile comparator comparing of a multiplicity of said profiles with different structures from each other, and creates candidates from said integrating link information; and a profile integration setting device determining which of said integration link information to be employed, from said candidates of the integrating link information.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram illustrating the principles of the present invention, according to an embodiment of the present invention;

FIG. 2 is a schematic view of the present invention, according to an embodiment of the present invention.

FIG. 3 is a structural example of the schema of the present invention, according to an embodiment of the present invention.

FIG. 4 is a structural example of the schema of the present invention, according to an embodiment of the present invention.

FIG. 5 is an example of a profile of the present invention, according to an embodiment of the present invention.

FIG. 6 is an example of a profile of the present invention, according to an embodiment of the present invention.

FIG. 7 is an example of a schema of the present invention, according to an embodiment of the present invention.

FIG. 8 is an example of the storage of a profile of the present invention, according to an embodiment of the present invention.

FIG. 9 is a schematic view of the integration link information of the present invention, according to an embodiment of the present invention.

FIG. 10 is an example of the integration link information of the present invention, according to an embodiment of the present invention.

FIG. 11 is a flowchart of the profile integration setting device of the present invention, according to an embodiment of the present invention.

FIG. 12 is a schematic view of the profile comparator of the present invention, according to an embodiment of the present invention.

FIG. 13 is a flowchart of the profile comparator of the present invention, according to an embodiment of the present invention.

FIG. 14 is a schematic view of the similarity judgment device of the present invention.

FIG. 15 is a flowchart of the similarity judgment device of the present invention, according to an embodiment of the present invention.

FIG. 16 is a schematic view of the schema similarity judgment device of the present invention, according to an embodiment of the present invention.

FIG. 17 is a flowchart of the sample data similarity judgment device of the present invention, according to an embodiment of the present invention.

FIG. 18 is a flowchart of the integration information transfer device of the present invention, according to an embodiment of the present invention.

FIG. 19 is an example of the display screen of the profile integration setting device of the present invention, according to an embodiment of the present invention.

FIG. 20 is a flowchart of the multiple profile manager of the present invention, according to an embodiment of the present invention.

FIG. 21 is a chart that shows the conventional correlation of the profile and the service that relates to the present invention, according to an embodiment of the present invention.

FIG. 22 illustrates a structure of the prior art that relates to the present invention, according to an embodiment of the present invention.

### DETAILED DESCRIPTION OF THE PREFERRED EMBODIMENTS

In the present invention, a profile integrator is used for the configuration process of integration between profiles with different accessing methods, data structures (schema), and data types.

A profiler integration device can include a profile integrator creating integration link information setting the integration of profile data that stores the settings of the information service for each user; a profile comparator comparing of a multiplicity of said profiles with different structures from each other, and creates candidates from said integrating link information; and a profile integration setting device determining which of said integration link information to be employed, from said candidates of the integrating link information.

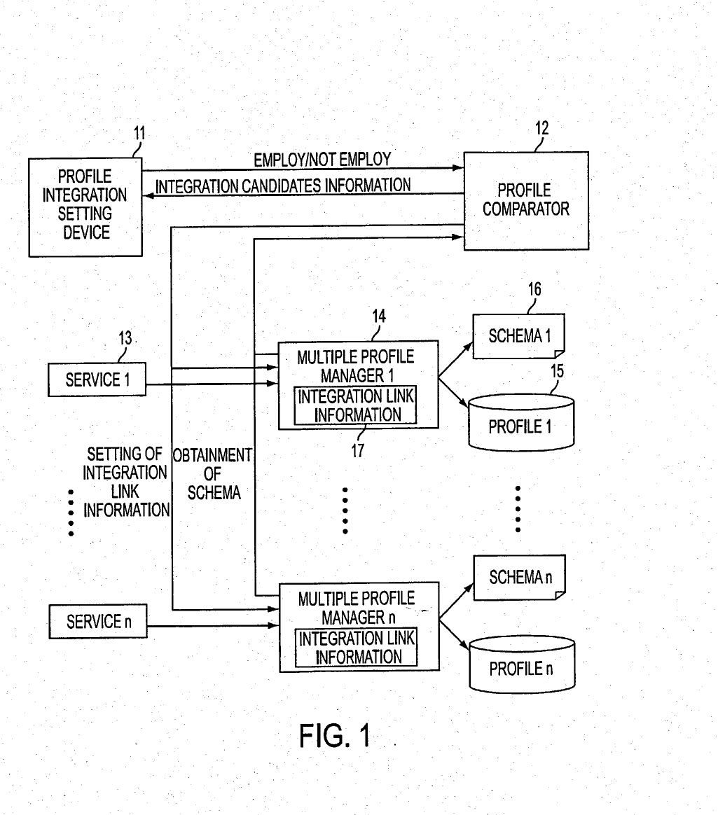

FIG. 1 is a block diagram illustrating the principles of the present invention. Referring now to FIG. 1, the operation and structure of the profile integrator is described.

Service 1 13 (and the other services) are programs, and in accordance with profile 1 15 (and others) set for every user, service is provided to each user. The structure of the profile 15 is defined by its schema 16.

When an administrator designates 2 profiles 17 to be integrated, the information is transmitted from a profile integration setting device 11 to a profile comparator 12. The profile comparator 12 obtains schemas of the designated 2 profiles, decides the similarity of the data structure thereof, and sends the evaluation results to the profile integration setting device 11. The received results of the similarity decision are displayed on the screen of the profile integration setting device as candidates for integration link information 17. The administrator classifies the multiple integration candidates proposed by the profile comparator 12 into employment and non-employment and then finally, instructs the confirmation of the profile integration setting information that is classified as employed. When the confirmation is instructed, the profile comparator 12 sets the integration link information 17 of the profile classified as employed to the multiple profile manager 14 and ends the integration procedure.

When the service 1 13 accesses one of the multiple profile managers (such as multiple profile manager 1 14) that have completed the integration procedure, the multiple profile manager 14 carries out the data operation on the profile 15 in the same computer based on the set integration link information 17, as well as communicates with the profile-managing computer 43 to conduct a linking operation.

As described above, the evaluation result generated by the profile comparator 12 is automatically displayed on the screen of the profile integration setting device, so that the profile integration can be carried out when the administrator simply selects the integration candidates proposed by the profile integration setting device 11, and consequently, the burden of the process can be significantly reduced. In addition, while utilizing profile resources accumulated by service providers, a new service can be provided promptly, or a new service site can be constructed to correspond with sophisticated structured data such as XML.

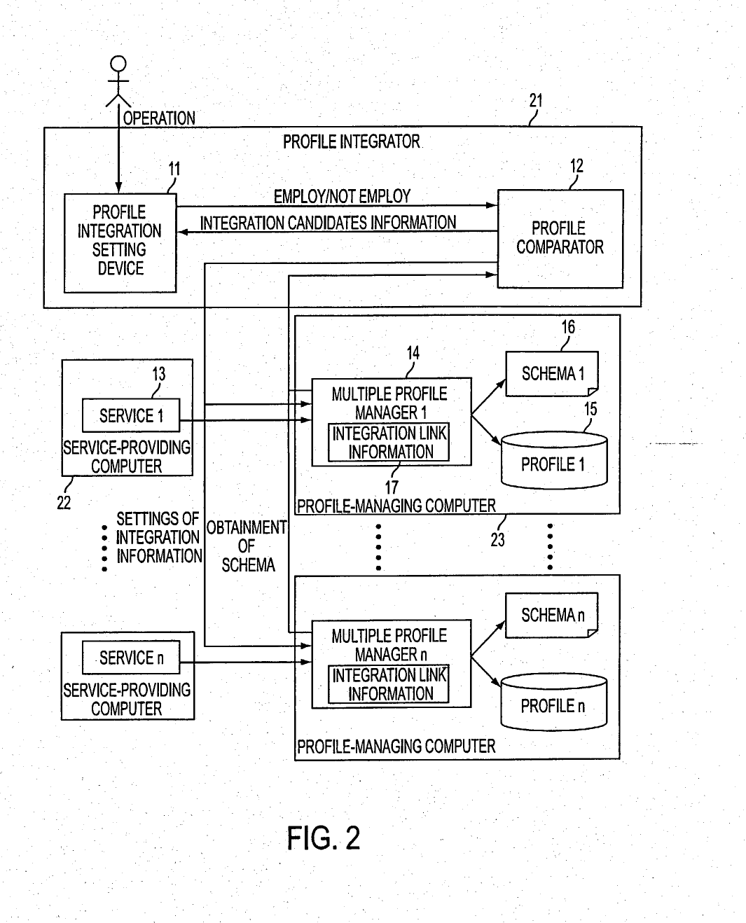

FIG. 2 illustrates a schematic view of the present invention.

Service 1 13 provides services for each user by being executed by the service-providing computer 22. The setting for each service for each user is stored by the profile-managing computer 23 as profile 15. The structure of the profile 15 is stored by the profile-managing computer 23 as schema 16.

The profile integrator 21 that carries out the profile integration process is comprised of a profile integration setting device 11 and a profile comparator. The profile integrator 21 is comprised of an input/output device with the administrator for the profile integration setting device 11.

The service-providing computer 22 may execute a multiplicity of services, and it may be comprised of multiple profile managers (such as multiple profile manage 1 14) to store profiles (such as profile 1 15) and schemas (such as schema 1 16).

The profile comparator 12 may be arranged in one of the multiple profile-managing computers (such as profile managing computer 23).

In addition, a computer that has profile integrator 21, service providing device 42, and a profile-managing computer 23 can be utilized.

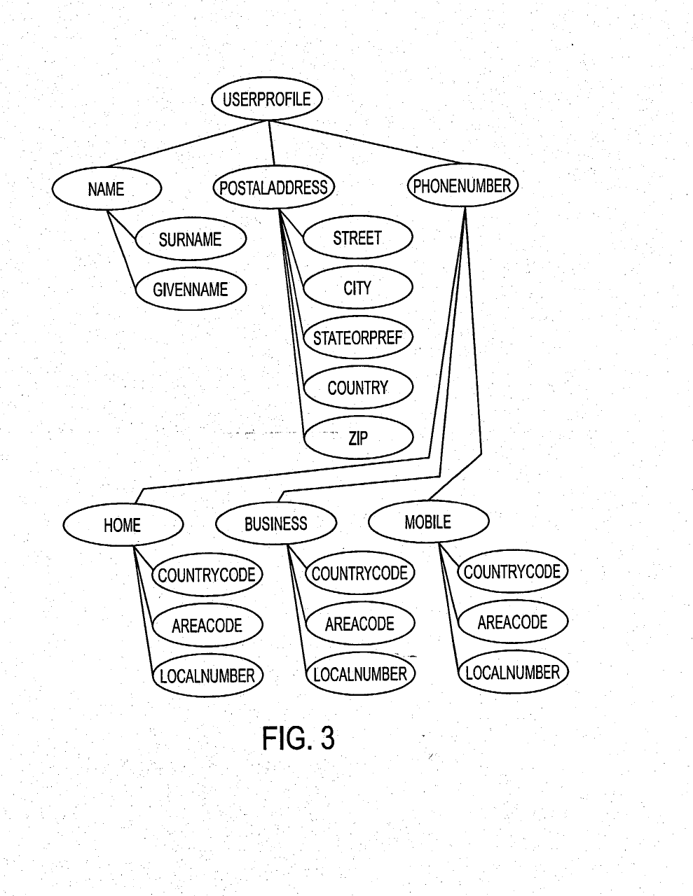

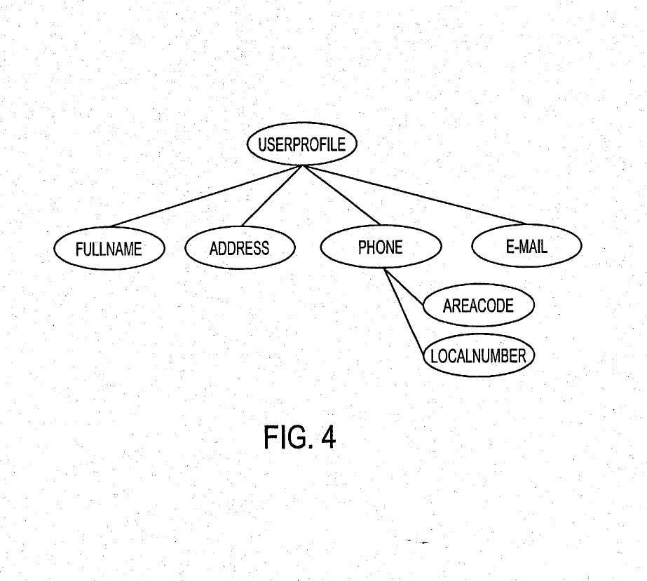

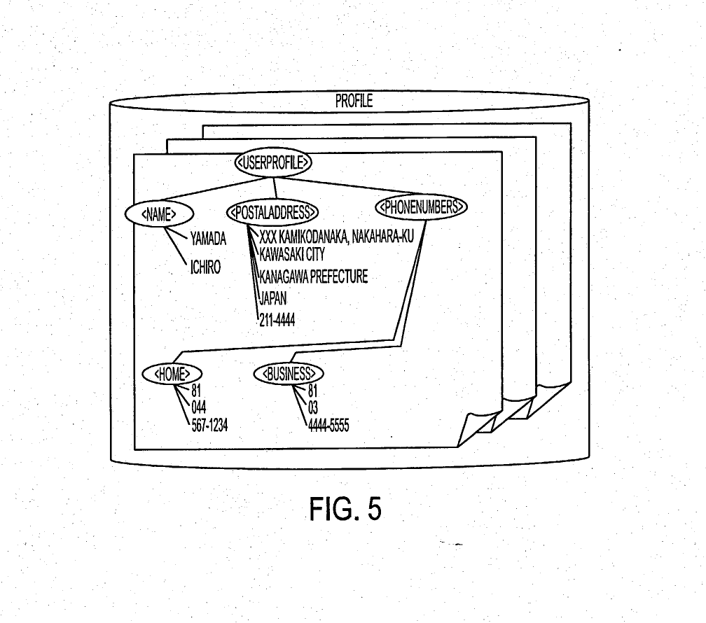

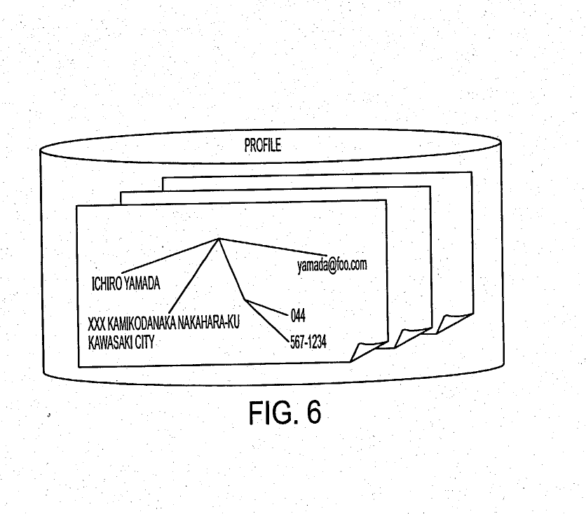

It is assumed that the profiles 15 handled in the present application handle not only a table format but also arbitrary tree structured data. The schema 16 shows the structure of profiles and the naming of the data elements contained therein. FIGS. 3 and 4 illustrate structural examples of the schema (such as schema 1 16). The essence of the profile (such as profile 1 15) is the actual data input based on the schema. FIGS. 5 and 6 illustrate profiles that correspond to the schemas 16 in FIGS. 3 and 4, respectively. In the profile managing computer 23 that is shared by multiple users, multiple data instances per each schema can be used. However, as with personal information managed by a personal computer, there are cases where one data instance is managed per each schema 16.

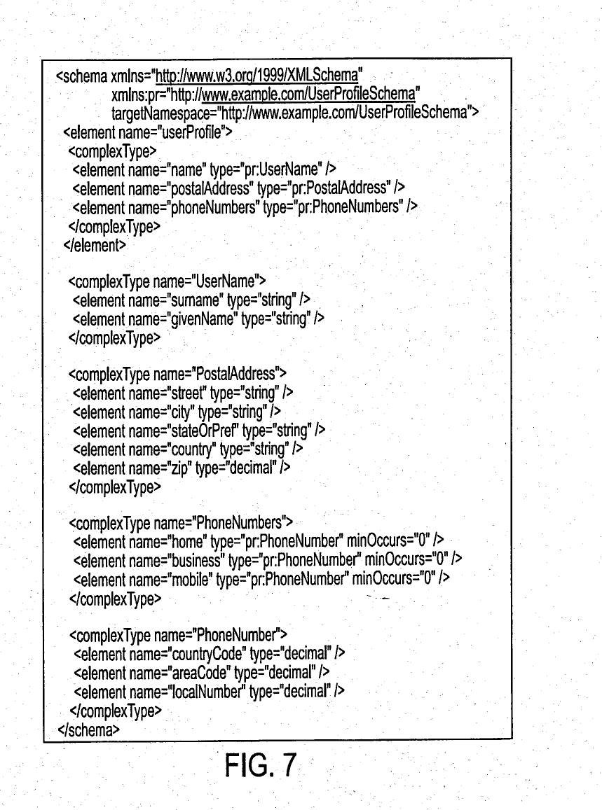

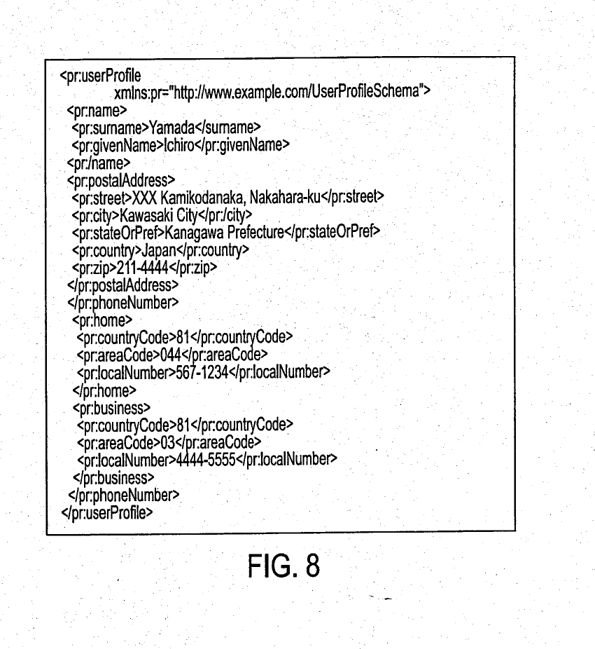

Furthermore, in the case a profile is allowed to be presented as an arbitrary tree structure, often, an XML format is employed as the representation. There exists an RDF schema and an XML schema as standard for the presentation of schema 16, however, in many cases, an XML schema that has a high affinity with object oriented languages is used. FIG. 7 illustrates an example of the definition in which schema 16 shown in FIG. 3 is defined by an XML scheme format. FIG. 8 shows an example of storage of profile that is defined by the schema with an XML schema format.

Each of the profiles 15 in FIGS. 5 and 6 are profiles that relate to different services 13. Here integration of the shared items for profile 1 15 in FIG. 5 and profile 1 15 in FIG. 6 is considered. Schemas 35 of profiles in FIGS. 5 and 6 are shown in FIGS. 3 and 4, respectively. For example, integration of the data element of the surname node and the data element of the givenName node under the name node under the user Profile node in FIG. 3, and the data element for the fullName node under the userProfile note in FIG. 4 are both represented as user name, therefore an integration state that is identical, can be set. Similarly, integration of the multiple nodes under the postalAddress node in FIG. 4 and the data element for the address node in FIG. 4 both represent a user's address, and therefore an integration state that is identical, can be set.

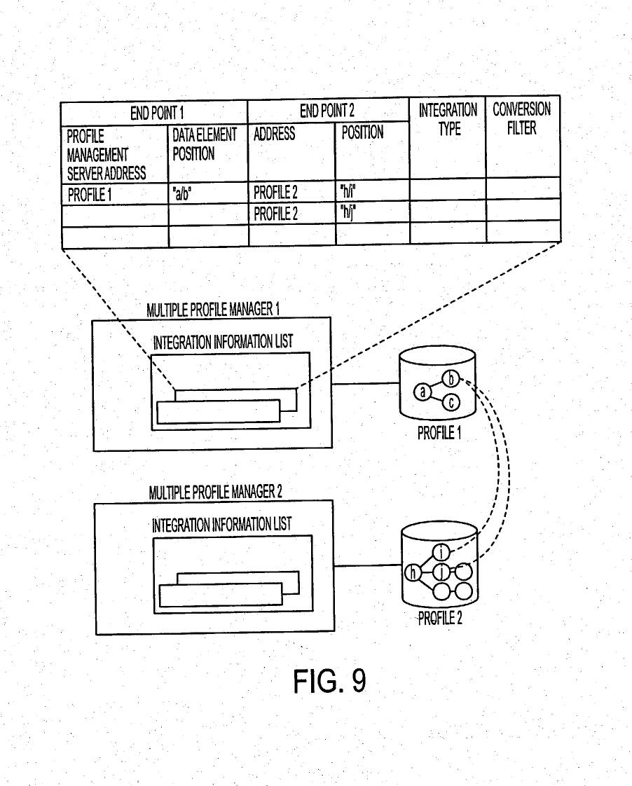

Integration link information 17 sets the above-mentioned two integration states. FIG. 9 illustrates a schematic view of the integration link information 17. These integration states between profiles are managed by the integration link information 17 that is comprised of one or more node position information items in one of the profiles, one or more node position information items in another profile, and conversion filter information for the data elements of these nodes, as shown in FIG. 9.

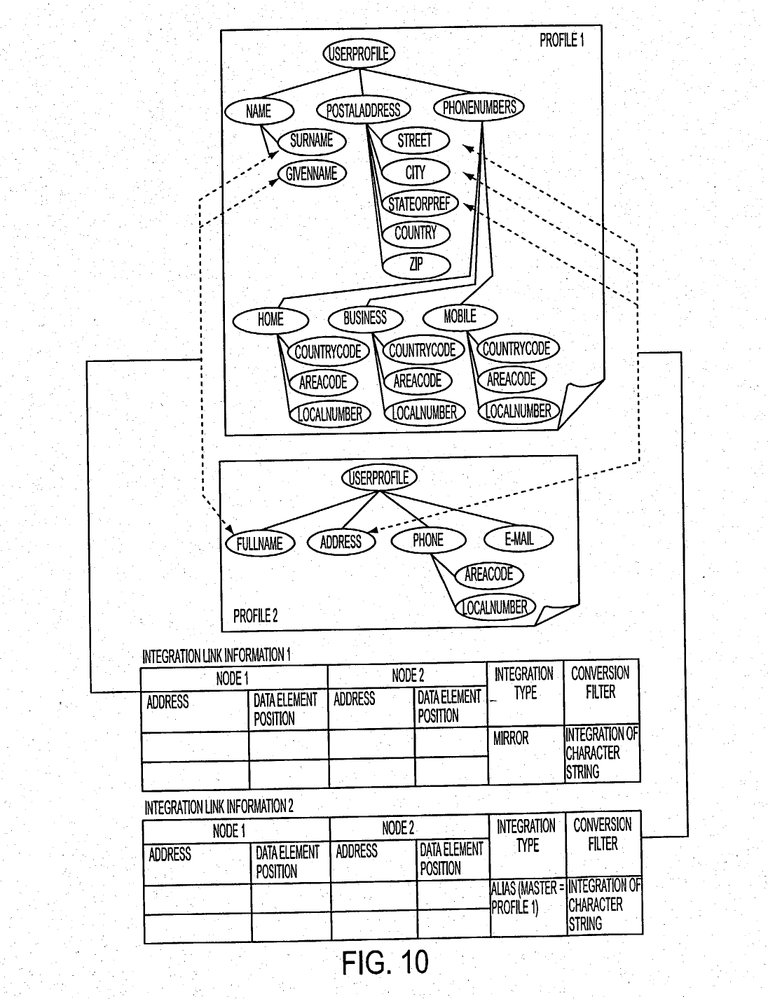

FIG. 10 illustrates an example of integration link information 17. FIG. 10 illustrates two integration states described above. In this example, the integration link information 17 represents integration correlation from the collection of data element positions of one of the profiles, and the collection of data element positions of another profile. It shows how each of the data elements are converted between profiles by a conversion filter. The conversion filter in 2 sets of integration link information 17 in FIG. 10 is defined as a character string, and it gives the additional information required to integrate the character strings. For example, the conversion filter of the integration link 1 information is shown as %11+%12+%2. Here %11 represents the 1st data element of the profile 1 (userProfile/name/surname), and %12 represents the 2nd data element of the profile 1 (userProfile/name/givenName). These represent that the result of the character string integration with a space ( ) is identical to %2 (namely, the data element of profile 2).

Other examples of a conversion filter are, a conversion of numerical data and character data as a 1-to-1 integration, and conversion of address data comprising multiple elements written in Japanese, and address data comprising multiple elements written in English as multiple to multiple integration.

In the example in FIG. 10, an integration type is shown in integration link information 17, and a mirror or alias is designated. As in the case of integration link information 17, when a mirror is designated, multiple profile manager 14 operates so that the substance of the data exists in both of the two profiles. On the other hand, when an alias is designated as in the case of integration link information 17, the substance of the data is stored only in one of the profiles and the multiple profile manager 14 operates so that a request for access to profile 15, issued to profile 15-2 is transferred to the profile 15-1.

In the present invention, the integration link information 17 is generated by the profile comparator 12. When the administrator gives an instruction from the profile integration setting device 11, the determined integration link information 17 is eventually transferred to the multiple profile manager 14.

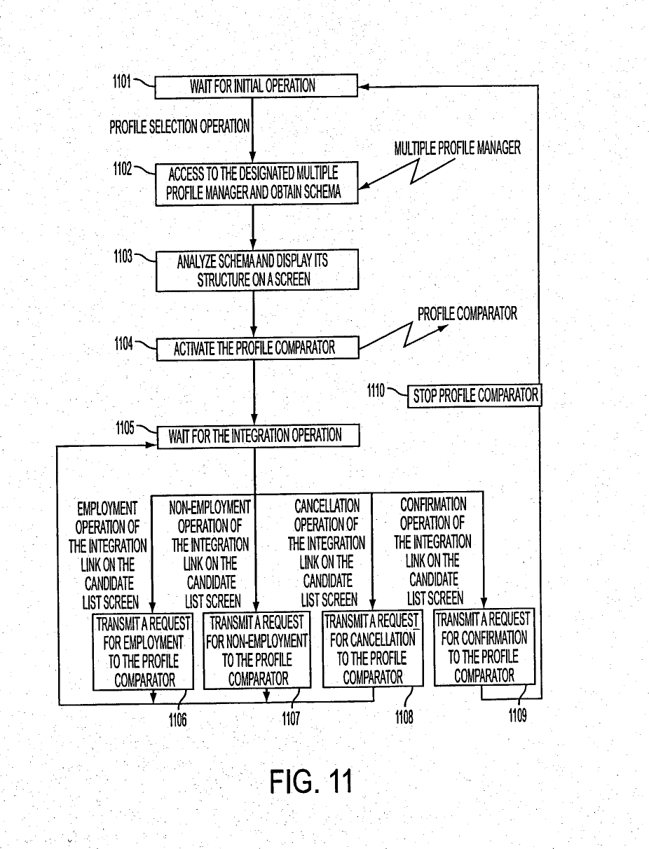

FIG. 11 shows a flowchart of the profile integration setting device 11, that shows the interactive operation with the profile comparator 12 that generates the integration link information 17.

While the profile integration setting device 11 is waiting for the initial operation (operation 1101), when a profile selection operation is carried out by an administrator, the profile integration setting device 11 accesses a designated multiple profile manager 14 and obtains schema 16 of the selected profile 15 (operation 1102). In addition, it analyses obtained schema 16 and displays its structure on the screen (operation 1103). Next, the profile integration setting device 11 activates the profile comparator 12 (operation 1104) and waits for the integration operation by the administrator (operation 1105).

Then, candidates for the integration link information 17 sent by the profile comparator 12 are displayed on the screen.

When the administrator selects one of the integration link information 17 items from the candidates for the integration link information 17 displayed on the screen, and the employment operation is carried out, then the profile integration setting device 11 sends a request for employment to the profile comparator 12 and returns to the state that waits for the integration operation (operation 1106).

In addition, when the administrator selects one of the integration link information 17 items from the candidates for the integration link information 17 displayed on the screen, the non-employed operation is carried out, and then the profile integration setting device 11 sends a request for non-employment to the profile comparator 12 and returns to the state that waits for the integration operation (operation 1107).

Furthermore, when the administrator select one of the integration link information 17 items from the employed list of operation 1106 or non-employed list of operation 1107, and carries out a cancel operation, then the profile integration setting device 11 sends a request to cancel to the profile comparator 12 and returns to the state that waits for the integration operation (operation 1108).

When the administrator carries out a confirmation operation for the employed list in operation 1106, the profile integration setting device 11 sends a request for confirmation (operation 1109) and the profile comparator 12 stops (operation 1110), and returns to the state that waits for the initial operation.

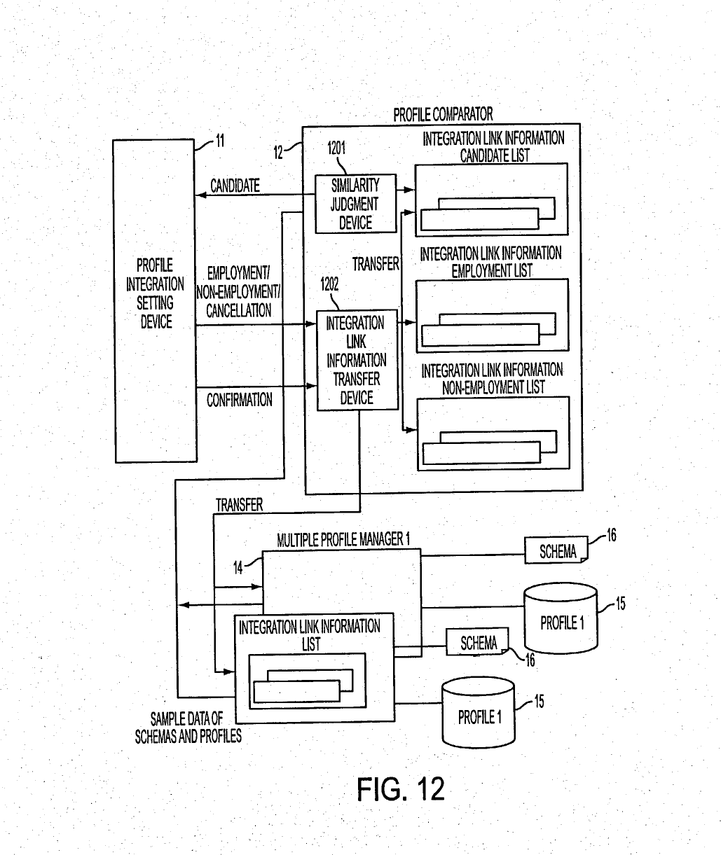

FIG. 12 illustrates a schematic view of the profile comparator 12. It is structured as follows. The profile comparator 12 reads schema 16 of the two profiles 15 to be integrated, and one of the data items of the profiles 15 as sample data by communicating with the multiple profile manager 14. The similarity judgment device 1201 compares schema 16 for the two profiles 15, and outputs candidate integration link information 17 and sends it to the profile integration setting device 11. Integration link information transfer device 1202 transfers the integration link information 17 by receiving an instruction from profile integration setting device 11.

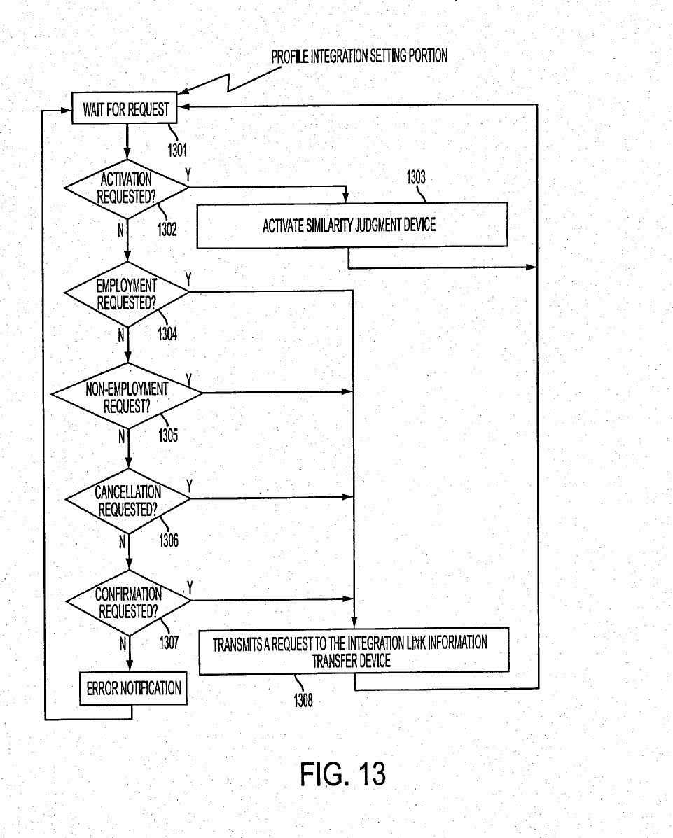

FIG. 13 is a flowchart of the profile comparator of the present invention.

The comparator waits for a request from the profile integration setting device 11 (operation 1301).

When the request from the profile integration setting device 11 is a request for activation of the similarity judgment device for the profiles (operation 1302), the similarity judgment device 1201 is activated (operation 1303).

When the profile integration setting device 11 employs the designated integration link information 17 during operation 1106, the employment process is carried out (operation 1304).

When the profile integration setting device 11 does not employ the designated integration link information 17 during operation 1107, the non-employment process is carried out (operation 1305).

When the profile integration setting device 11 cancels designated integration link information 17 during operation 1108, a canceling process is carried out (operation 1306).

When the profile integration setting device 11 confirms the designated integration link information 17 during operation 1109, a confirmation process is carried out (operation 1307).

The integration link transfer device 1202 operates so that it transfers the request to the similarity judgment device 1201 or integration link transfer device 1202 depending on the processes in operations 1304 to 1307 (operation 1308).

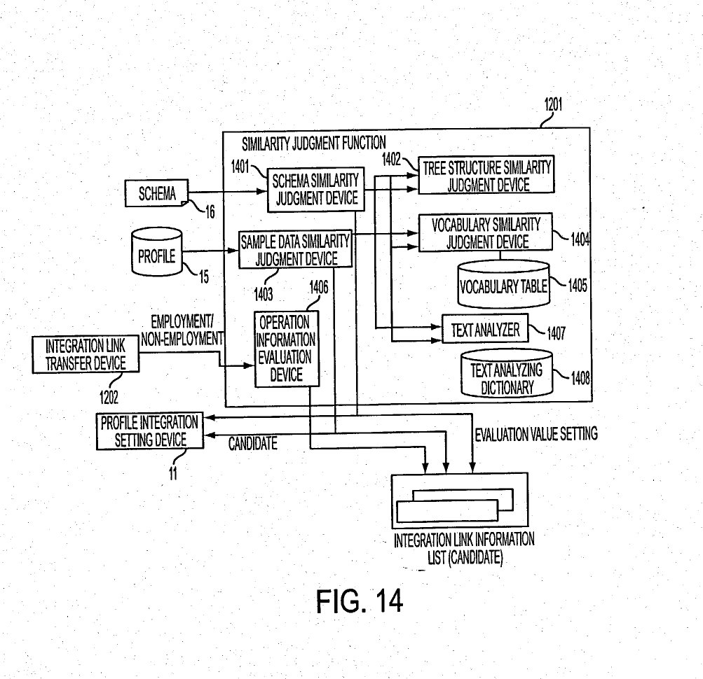

FIG. 14 illustrates a schematic view of a similarity judgment device 1201. The similarity judgment device 1201 is comprised of a schema similarity judgment device 1401 and a sample data similarity judgment device 1403.

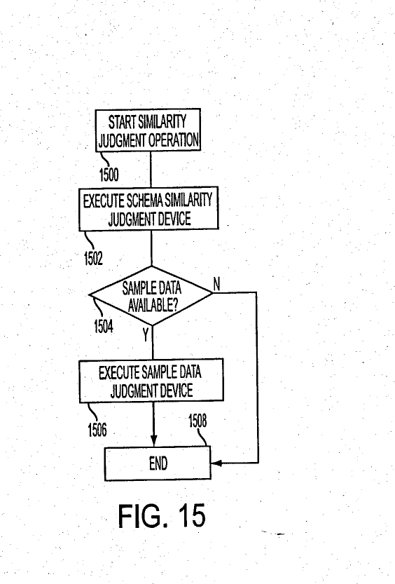

FIG. 15 is a flowchart of the similarity judgment device of the present invention. The similarity judgment device 1201 executes a schema similarity judgment device 1401 and a sample data similarity judgment device 1403 in order, and generates candidates for integration link information 17, while setting those evaluation values.

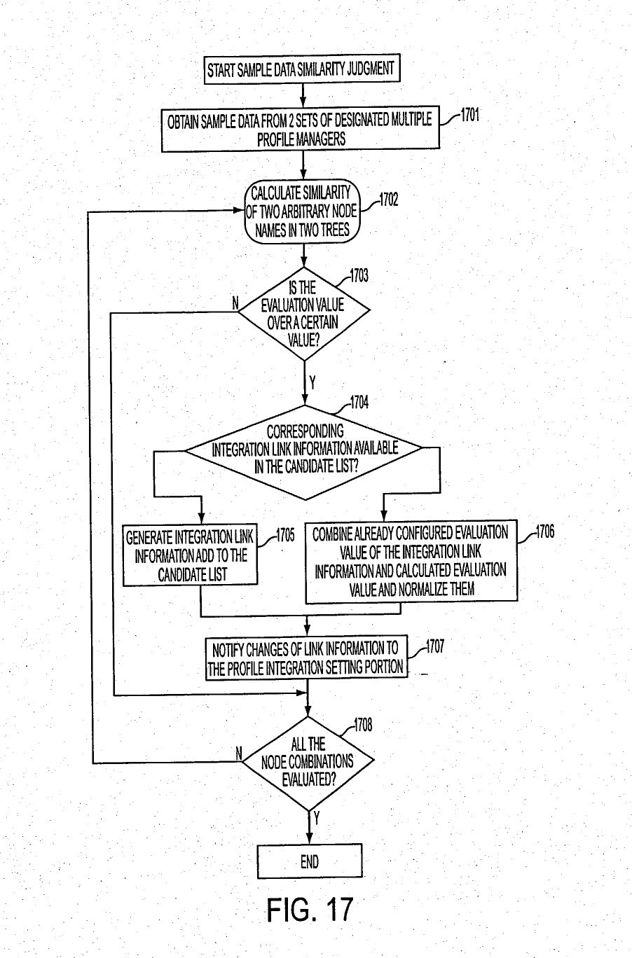

In addition, both the schema similarity judgment device 1401 and sample data similarity judgment device 1403 carry out common operations such as a comparison of the similarity of the data's tree structure or a comparison of the similarity of the vocabulary included in the data. Therefore, as shown in FIG. 17, tree structure similarity judgment device 1402 and vocabulary similarity judgment device 1404 are provided in the similarity judgment device 1201 and these are executed and shared by schema similarity judgment device 1401 and sample data similarity judgment device 1403.

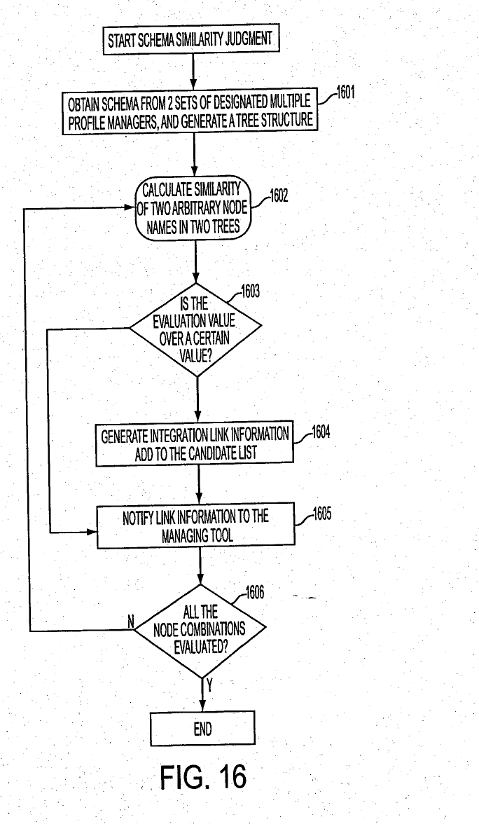

FIG. 16 is a schematic view of the schema similarity judgment device of the present invention.

When the initiation of the schema similarity judgment is instructed, schemas are obtained from the designated two profile managers, and tree structured internal data is created (operation 1601). One arbitrary node is selected from each of the created two trees, and the evaluation value of the similarity of the node name is calculated (operation 1602). Here, in order to improve the effectiveness of the evaluation value, tree structure similarity judgment device 1402, vocabulary similarity judgment device 1404 and text analyzer 1407 may be used in combination.

The tree structure similarity judgment device 1402 extracts a path name that includes a parent node from the route node to be compared, and then, even if the node name to be compared is different, if the upper rank node name is similar, or the structure of the child node of the node to be compared is similar, it works so that it gives an evaluation value with a certain rate.

The vocabulary similarity judgment device 1404 uses vocabulary table 1405, and even if the node names to be compared are not identical, if two node names to be compared are judged to be synonyms, it works so that it gives an evaluation value with a certain rate.

Text analyzer 1406 uses text analyzer dictionary 1408 to divide the node name to be compared into meaningful words, and gives weight to the meaning of each word, and then by taking these into account, calculates the evaluation value.

After the evaluation value of the similarity is calculated, if the evaluation value is above a certain value (operation 1603), integration link information 17 sets two node positions for the evaluation target and the evaluation value is generated and it is added to the candidate list storage area of the integration link information 17 (operation 1604). Next, added integration link information 17 is passed to the profile integration setting device 11 (operation 1605).

The above-mentioned processes are repeated for all the combinations of the nodes (operation 1606).

FIG. 17 illustrates a flowchart of the sample data similarity judgment device 1403.

When the initiation of the sample data similarity judgment is instructed, sample data is obtained from the designated two profile managers (operation 1701). Next, arbitrary nodes are selected from the trees of the two sets of sample data, and the similarity of the node value is calculated (operation 1702). Here, in order to improve the effectiveness of the evaluation value, tree structure similarity judgment device 1402, vocabulary similarity judgment device 1404 and text analyzer 1407 may be used in combination.

The tree structure similarity judgment device 1402 extracts a path name that includes the parent node from the route node to be compared, and then even if the node name to be compared is different, if the upper rank node name is similar, or the structure of the child node of the node to be compared is similar, it works so that it gives an evaluation value with a certain rate.

The vocabulary similarity judgment device 1404 uses vocabulary table 1405, and even if the node names to be compared are not identical, if two node names to be compared are judged to be synonyms, it works so that it gives an evaluation value with a certain rate.

Text analyzer 1407 uses text analyzer dictionary 1408 to divide the node names to be compared into meaningful words, and gives weight to the meaning of each word, and then by taking these into account, the evaluation value is calculated.

After the evaluation value for the similarity is calculated, if the evaluation value is above a certain value (operation 1703) it investigates whether the integration link information 17 that corresponds to the combination of the compared node exists in the candidate list storage area (operation 1704). If corresponding integration link information 17 does not exist, an integration link information 17, which is set with two node positions for the evaluation target and an evaluation value, is generated and it is added to the candidate list storage area of the integration link information 17 (operation 1705). If corresponding integration link information 17 exists, a value with the already set evaluation value of the integration link information and the newly calculated evaluation value are added and normalized and set as the integration link information 17 (operation 1706). Next, the added or corrected integration link information 17 is passed to the profile integration setting device 11 (operation 1707). The above-mentioned processes are repeated for all the combinations of the nodes (operation 1708).

In the case a similarity judgment for schemas 16 is carried out using the schema 16 in aforementioned Figure. 3, the other schema 16 shown in FIG. 4, is considered. Here, the full path name from the route of each node is compared, and then

userProfile/phone/areaCode

userProfile/phone/localNumber

in FIG. 4 and

userProfile/phoneNumbers/home/areaCode

userProfile/phoneNumbers/home/localNumber

in FIG. 3, and also the device

userProfile/phoneNumbers/business/areaCode

userProfile/phoneNumbers/business/localNumber

and the device

userProfile/phoneNumbers/mobile/areaCode

userProfile/phoneNumbers/mobile/localNumber

are similar. Therefore, it operates by setting the evaluation value of the similarity high for the phone node in FIG. 4, and the home node, business node and mobile node in FIG. 3. An example of the evaluation function that determines the evaluation value of the parent node with the structure of a small node is shown as follows.

Effect of the evaluation value of the node=rate of the node evaluation effect* (evaluation value of small node 1+evaluation value of small node 2+. . . )/Number of small nodes

In the case of the above-mentioned example, let the rate of the node evaluation effect be 0.8, then:

Effect of the evaluation value of the phone node=0.8*(0+1+1+1)/4=0.6.

An example of a vocabulary similarity judgment is shown. If one of the profiles 15 has a node called mailAddress, and the other profile 15 has a node called e-mail, when a simple partial identification of the character string is carried out, the similarity evaluation value is 0. However, if words called mailAddress and e-mail are registered with an evaluation value of 0.8 in the vocabulary table, the similarity of these nodes can be proposed as 0.8.

Next is an example that utilizes text analysis device 1407, where one profile 36 has a node called currentAvailableTerminals and the other profile 36 has a node called terminalids, and both are storing the address list of the communication terminal that is owned by users. In this case, when a simple partial identification of the character string is carried out, the similarity evaluation value is 0. However, text analyses allow the calculation of a similarity evaluation by dividing the node name into multiple words. In the case of the Japanese language, a word cannot be divided without a dictionary so that it is necessary to utilize a general portable element analysis device. However, when the node name of schema is defined in the English alphabet, in many cases, a general schema is defined so that the division of the word can be understood by capitalizing the first letter of the word (It is called the intercap method), or inserting an underscore “ ” between words. In these cases, a word dictionary is not required and instead a text analysis device for intercap 1407 or a text analysis device for underscore 1407 can be installed. The above-mentioned example shows the division of word with intercapping, and therefore these two node names are divided into words as follows.

currentAvailableTerminals=current+available+terminals

terminallds=terminal+ids

Regarding the collection of two words, for example, a linear partial identity evaluation for identical character string length is carried out:

The similarity evaluation value of currentAvailableTerminals and terminallds=(Number of characters of current*partial identity rate+number of characters of available*partial identity rate+number of characters of terminals*partial identity rate)/number of characters of currentAvailableTerminals=(7*0.0+9*0.0+9*8/9)/(7+9+9)=0.32

In addition, when a dictionary that gives weight to the meaning of words is prepared and the weight of current and available is set to 0.3, and the weight of terminal is 1.0, then the evaluation is similarity evaluation value for the currentavailable Terminals and terminallds=

$$= ( {7}^{*} {( 0.3 / 1.6 )}^{*} 0.0 + {9}^{*} {( 0.3 / 1.6 )}^{*} 0.0 + {9}^{*} {( 1.0 / 1.6 )}^{*} 8 / 9 / ) / \\ ( {7}^{*} ( 0.3 / 1.6 ) + {9}^{*} ( 0.3 / 1.6 ) + {9}^{*} ( 1.0 / 1.6 ) ) \\ = 0.57$$

Therefore, it can be proposed as a candidate with a somewhat high similarity evaluation.

As described above, the similarity judgment device sets an appropriate evaluation value to the integration link information 17 that will be the candidate for the integration, and sends it to the profile integration setting device 11 in series. When an administrator carries out the operation of employing, not employing, canceling or confirming the integration link displayed on the screen of the profile integration setting device 11, a request that corresponds to those operations is sent from the profile integration setting device 11 to the similarity judgment device. As shown in FIG. 15, these requests are transferred to the integration link information transfer device 1202 and an appropriate process is carried out.

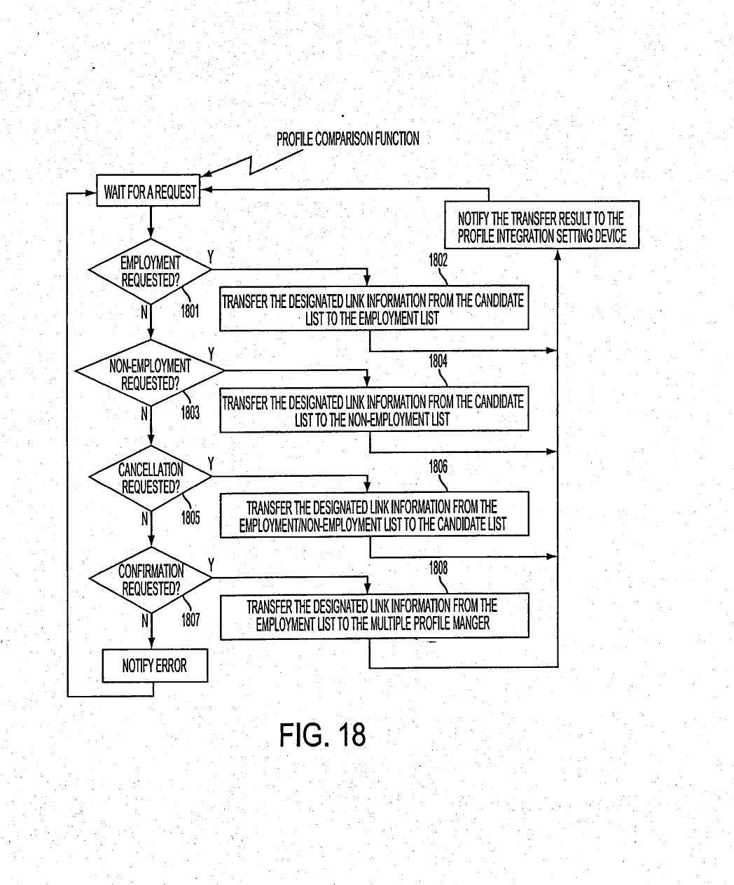

FIG. 18 illustrates a flowchart of the integration information transfer device 1202.

The integration information transfer device 1202 carries out the corresponding process when it receives any one of the requests for employment, request for non-employment, request for canceling or request for confirming of the entire candidate list from the profile integration setting device 11. When the request from the profile integration setting device 11 is not for employment, non-employment, canceling or confirming, it sends back an error and returns to the state of waiting for a request.

In the case a request to employ the integration link information 17 is received (operation 1801), it transfers the designated integration link information 17 from the candidate list to the employment list, and then passes the transfer result to the profile integration setting device 11 (operation 1802).

In the case a request to not employ the integration link information 17 is received (operation 1803), it transfers the designated integration link information 17 from the candidate list to the non employment list, and passes the transfer result to the profile integration setting device 11 (operation 1804).

In the case a request for canceling employment or non employment of the integration link information 17 is received (operation 1805), it transfers the integration link information 17 in the employment or non-employment list to the candidate list, and passes the transfer result to the profile integration setting device 11 (operation 1806).

In the case of a request for confirming the integration link (operation 1807), it transfers all the integration link information 17 in the employment list to the integration link information 17 list in the multiple profile manager 14, and passes the transfer result to the profile integration setting device 11 (operation 1808).

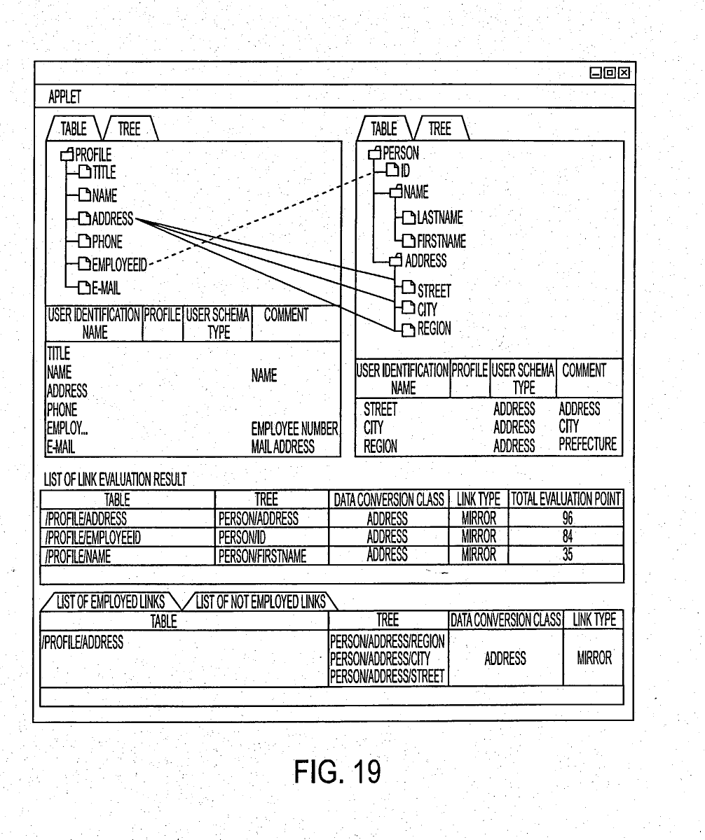

FIG. 19 illustrates an example of the screen display of the profile integration setting device 11. The top half of the screen shows the state of schemas 16 for 2 profiles 15 to be integrated. Each schema is divided into the device displayed on the tree, and the device displayed with the table format for each element name. In addition, devices where links are made in which each of the data elements are identical, can be viewed by the data elements being connected by bold lines.

The bottom half of the screen displays a list of link candidates proposed by the profile comparator in a table format as a list of link evaluation results on the screen, and the evaluation value for each link candidate is indicated as a percentage. In addition, the employment link list and unemployment link list are displayed in a table format in a similar manner. The display of the table contents of these two tables can be switched using tabs with each of the names.

Here, for example, the link information between /Profile/employeeID and person/ID (evaluation point 64) that is proposed by the link evaluation result is selected, and then employeeID and ID are linked with a dotted line in the tree display device of the schema 16 in the top half of the screen, so that the data elements that are linked can be understood. When the confirmation operation is carried out here, the link information for /Profile/employeeID and person/ID is eliminated from the link evaluation result list and is displayed in the employment link list. At the same time, the drawing of the link indicated as a dotted line in the top half of the screen changes to a solid line. As described above, selecting the integration of the profiles 15 with a complicated structure from candidates proposed by the profile integration setting device 11 allows a simple integration operation.

As described above, the correctly configured integration information is accumulated in the integration link information 17 list in the multiple profile manager 14. When a service generates a data accessing request for obtaining or replacing the profile 15 to the multiple profile manager 14, the multiple profile manager 14 carries out a process appropriate for the integration state by referring to the integration link information list.

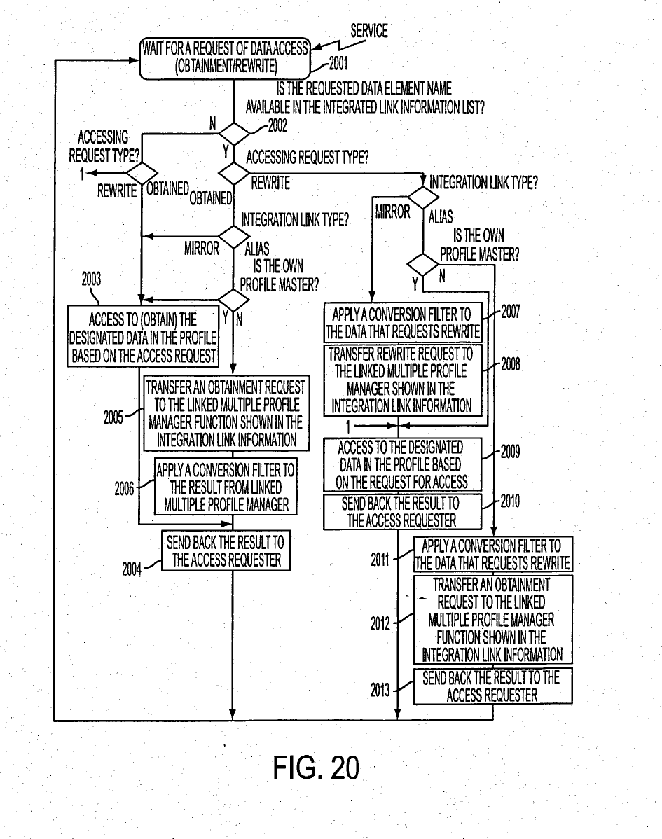

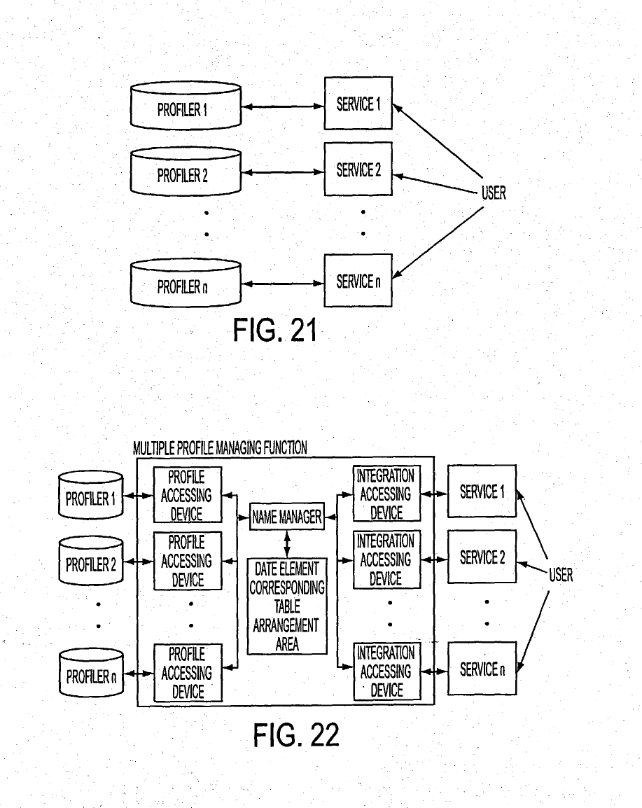

FIG. 20 shows a flowchart of the multiple profile manager. When the multiple profile manager 14 receives a data access request (operation 2001), whether the data element name of the requested profile 15 exists in the integrated link information 17 list is checked (operation 2002). If it does not, it accesses its own profile 15 as a normal process and based on the access request, it accesses the designated data in the profile 15, and then obtainment or rewriting is carried out (operation 2003)

If there is the requested data element name in the integration link information 17 list, the access request type from the service is checked and the process is branched depending on whether it is a request for obtainment or a request for rewriting.

In the case it is a request for obtainment, as long as its own profile 15 is the master, regardless of whether the integration link type is a mirror or the integration link type is an alias, an access is made to its own profile, and according to the access request, an access is made to the designated data in the profile, and then it is obtained (operation 2003). Thus, the result is sent back to the service that requested the access (operation 2004).

When the integration link type is an alias and its own profile is not a master, then a request for obtainment is transferred to the multiple profile manager 14 where a link is made by the integration link information 17 (operation 2005). When the link obtainment result is sent back from the multiple profile manager 14, the conversion filter shown in integration link information 17 is applied to the data (operation 2006) and then the obtained result is sent back to the service that made the request for the access (operation 2004).

In the event that the access request type is a request for rewriting, if the integration link type is a mirror, or the integration link type is an alias and its own profile is not a master, the conversion filter shown in the integration link information 17 is applied to the data for the parameter where the rewriting request is made (operation 2007), and a request for rewriting is transferred to the linked multiple profile manager 14 (operation 2008).

In addition, if the integration link type is a mirror, or the integration link type is an alias and its own profile is the master, an access is made to the designated information in the profile according to the request for accessing and a rewriting process is carried out (operation 2009), and then the result is sent back to the service that made the access (operation 2010).

If the integration link type is an alias and its own profile is the master, the conversion filter shown in the integration link information 17 is applied to the data (operation 2011), and a request for rewriting is transferred to the linked multiple profile manager 14 (operation 2012) and then the result is sent back to the service that made the access (operation 2013).

As described above, even if profiles exist independently from each other, profiles which are integrated, as set by the profile integration setting device 11, can be utilized.

Although an illustration is omitted, the hardware for the profile integrator 41, the service-providing computer 42 and the profile-managing computer 43 can be realized by being comprised of one or multiple CPUs, a main storage device, an external storage device such as a hard disk, etc., a communication device, and a bus that connects everything together. The software program to make this computer function as the profile integrator 41 can be stored in an appropriate storage media such as a portable memory medium that is readable by a computer, semiconductor memory or hard disks.

As described above, with the present invention, a profile integrator simplifies data integration of multiple profiles with different structures, allows data integration of profiles with complicated structures and improves the convenience of the services where the profile is set, and consequently greatly contributes to the startup of a new service.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A profile integration device comprising:
a profile integrator creating integration link information setting the integration of profile data that stores the settings of the information service for each user;
a profile comparator comparing of a multiplicity of said profiles with different structures from each other, and creating candidates from said integrating link information; and
a profile integration setting device determining which of said integration link information to be employed, from said candidates of the integrating link information.

2. A profile integrator as recited in claim 1, wherein said profile comparator comprises a schema similarity judgment device that makes a comparison of the similarity of the structure of said profile.

3. A profile integrator as recited in claims 1, wherein said profile comparator comprises a sample data similarity judgment device that reads out the sample data from said profile, and makes a comparison of the similarity of the vocabulary contained in the sample data.

4. A profile integrator as recited in claim 1, wherein said profile integration setting device outputs the candidates of said integration link information, allowing the administrator to make the selection of a candidate.

5. A profile integrator as recited in claim 1, wherein said profile integration setting device displays multiple profile structures.

6. A multiple profile manager that manages profiles storing the settings of an information service for each user comprising:
an integration link information storage device that stores the integration link information that sets the data integration of different profiles, wherein
the integration link information storage device processes data integration of different profiles that are configured in the integration link information by linking to other multiple profile managers.

7. A multiple-profile management method that manages profiles that store the settings for an information service of each user, the method comprising:
comparing of a multiplicity of profiles with different structures with each other, and creates candidates for said integration link information; and
determining said integration link information to be used from said candidates of the integration link information.

8. A multiple-profile management method managing profiles that store the settings for an information service of each user, comprising:
processing data integration of different profiles that are set in integration link information by linking to other multiple profile managing methods.

9. A computer readable storage medium storing a program which creates integrating link information to configure the data integration of a profile that stores the settings for an information service of each user, by performing:
comparing a multiplicity of said profiles with different structures with each other, and creates candidates for said integration link information; and
determining that said integration link information be employed from said candidates of the integration link information.

10. A computer readable storage medium storing a program which creates integration link information to configure data integration of a profile that stores a configuration for an information service of each user, by performing:
a data integration procedure for a different profile configured by the integrating link information stored in an integrating link information storage device by linking to other multiple profile managing methods.

11. An apparatus, comprising:
a judging unit judging similarity of elements of a first profile and a second profile; and
a linking unit linking respective elements of the first profile and the second profile judged similar by the judging unit.

12. A method, comprising:
judging similarity of elements of a first profile and a second profile; and
linking respective elements of the first profile and the second profile judged similar by the judging.

13. A computer readable storage, controlling a computer by:
judging similarity of elements of a first profile and a second profile; and
linking respective elements of the first profile and the second profile judged similar by the judging.

14. An apparatus, comprising:
judging means judging similarity of elements of a first profile and a second profile; and
linking means linking respective elements of the first profile and the second profile judged similar by the judging unit.
